(19) United States
(12) Patent Application Publication
(10) Pub. No.: US 2019/0248105 A1
(43) Pub. Date: Aug. 15, 2019

(54) COVER FOR A SEAT AND METHOD FOR PRODUCING A COVER

(71) Applicant: Adient Engineering and IP GmbH, Burscheid (DE)

(72) Inventors: Niels MONDELAERS, Laakdal (BE); Uwe SCHULZE, Köln (DE)

(21) Appl. No.: 15/944,937

(22) Filed: Apr. 4, 2018

(30) Foreign Application Priority Data
Feb. 12, 2018 (DE) 10 2018 202 153.8

(51) Int. Cl. B32B 5/26; B32B 1/00; B32B 5/02; B32B 7/12; B32B 9/02; B32B 9/04; B32B 27/12; B32B 27/30; B32B 37/10; B32B 37/12; B32B 37/18; B29C 43/20; B29C 65/48; B60N 2/58

(52) U.S. Cl. CPC B32B 5/26; B29K 2101/12; B32B 5/022; B32B 5/024; B32B 7/12; B32B 9/025; B32B 9/047; B32B 27/12; B32B 27/304; B32B 37/10; B32B 37/12; B32B 37/182; B29C 43/203; B29C 65/48; B60N 2/5891; B32B 2250/03; B32B 2262/0276; B32B 2305/188; B32B 2305/20; B32B 2307/724; B32B 2310/027; B32B 2317/08; B32B 2327/06; B32B 2367/00; B32B 2479/00; B32B 2605/003; B32B 1/00

(57) ABSTRACT

A cover (1), in particular a backrest cover or a lateral cover for a vehicle seat, is molded from a covering material layer (2), in particular from a covering material blank (2.1) and from a carrier material layer (4), in particular from a carrier material blank (4.1). An adhesive non-woven (3) or an adhesive layer is disposed between the covering material blank (2.1) and the carrier material blank (4.1).

### CROSS REFERENCE TO RELATED APPLICATIONS

This application claims the benefit of priority under 35 U.S.C. § 119 of German Application 10 2018 202 153.8, filed Feb. 12, 2018, the entire contents of which are incorporated herein by reference.

### FIELD OF THE INVENTION

The invention relates to a cover for a seat, in particular a backrest cover or a lateral cover for a vehicle seat. The invention furthermore relates to a method for producing such a cover.

### BACKGROUND OF THE INVENTION

A fiber-composite material for a carrier component is known from DE 30 22 017 C2.

Covers for a vehicle seat are generally known as a trim of lateral and/or backrest regions of the vehicle seat.

### SUMMARY OF THE INVENTION

It is an object of the present invention to provide a cover that is improved in comparison to the prior art, in particular a light and strong cover, and an improved method for producing such a cover.

The object is achieved according to the invention by a cover for a seat, in particular by a backrest cover and/or a lateral cover for a vehicle seat, wherein the cover is molded from a covering material blank, or a covering material layer, and from a carrier material blank, or a carrier material layer, and from an adhesive non-woven that is disposed therebetween. The adhesive non-woven can be configured and placed therein as a separate tier or layer, or be prefabricated on the carrier material. In other words, the cover or trim according to the invention is made as a separate component, in particular as a separate composite component or a 3D molded part, the covering material blank or the covering material layer thereof being interconnected in a materially integral manner with the carrier material blank or the carrier material layer by means of the in particular porous and/or breathable adhesive non-woven or adhesive layer disposed therebetween.

The advantages that can be achieved by the invention are in particular that the weight of such a cover or trim is particularly light. Moreover, one and the same press can be used for different covering materials such as leather, vinyl, or woven fabric. The production of the cover in various forms becomes simpler and more cost-effective on account thereof. Such a cover herein forms in particular a backrest or lateral cover/trim for a vehicle seat.

In one potential embodiment, the covering material and the carrier material are joined to one another by means of the adhesive non-woven or of the adhesive layer by a pressure-forming and pressure-joining method. For example, the covering material and the carrier material can joined to one another by means of the adhesive non-woven or of the adhesive layer by a pressure-forming and pressure-joining method by means of high-frequency energy in the form of an electromagnetic field (also referred to in short as high-frequency welding method). The adhesive non-woven/adhesive layer that is disposed between the covering material layer/covering material blank and the carrier material layer/carrier material blank is activated by such a pressure-forming and pressure-joining method. The joint between the covering material blank/covering material layer and the carrier material blank/carrier material layer herein is influenced in particular by the pressure, the welding output, the welding duration, and the cooling duration.

The adhesive non-woven has a porous structure and thus open intermediate spaces. The adhesive non-woven can be disposed as a separate layer between the carrier material layer and the covering material layer. Alternatively, the adhesive material can be prefabricated on the carrier material. The adhesive material herein is applied to that surface side of the carrier material that points towards the covering material.

In one potential embodiment, the covering material is a vinyl material, in particular a laminated or non-laminated vinyl material, for example a polyvinylchloride (in short referred to as PVC). Alternatively, the covering material can be a laminated or non-laminated textile material, in particular a woven fabric, or a laminated or non-laminated natural material, in particular leather. The covering material is optionally pre-treated and available as an endless material, for example, which is cut to size for the production of the cover or the seat trim. A covering material blank that results therefrom has a blank shape that is adapted to the final shape of the cover. This blank shape of the covering material is also referred to as the covering material blank The covering material can be reinforced and/or coated. The covering material can also be configured so as to be smooth or porous. The covering material is thin in comparison to the carrier material, whereas the carrier material is of a greater thickness.

In a further embodiment, the carrier material is a carrier non-woven, in particular a press felt or a carpet or a warp or weft knitted fabric, for example from plastics fibers and/or natural fibers and/or reinforcement fibers. The fibrous material can be pre-shaped and optionally be pre-treated. The fibrous material is available as an endless material, for example, which is cut to size for the production of the cover. A carrier material blank resulting therefrom has a blank shape that is adapted to the final shape of the cover. This blank shape of the carrier material is also referred to as the carrier material blank The fibrous material can be formed from one or more different materials, for example from polyester, polyethylene, polypropylene and/or polyurethane. Said fibrous material can be formed from randomly oriented fibers, in particular from recycled or virgin natural and/or plastics fibers. The carrier non-woven can be formed from a three-dimensional stochastically oriented fibrous material. Alternatively, said fibrous material can be a woven or a non-woven fabric. Said fibrous material can optionally be thermally pre-treated. Said fibrous material herein is advantageously a three-dimensional stochastically oriented fibrous material. Plastics fibers are formed from a thermoplastic material, for example, in particular from a modified and weldable thermoplastic material. For example, the plastics fibers are formed from polyethylene terephthalate (PET), from polyester, or from a synthetic polymer, in particular from polylactic acid (PLA). A mixture of fibers from various plastics is also possible.

According to the disclosure, the adhesive non-woven is in particular a water-free and/or solvent-free adhesive non-woven, for example a co-polyester non-woven or a thermoplastic non-woven. The adhesive non-woven has in particular an open structure. This means that hollow intermediate spaces are present in the adhesive non-woven. An open adhesive connection is configured upon activation, in particular by heat and pressure over a specific time.

The cover surprisingly has a thickness in a range from 3 mm to 5 mm, in particular from 4.0 mm to 4.5 mm. It has moreover been surprisingly established that such a thin cover has a hardness of more than 60 Shore-A, in particular of 65 Shore-A in the case of a 1000 g carrier non-woven, or of 62 Shore-A in the case of an 800 g carrier non-woven.

The cover is preferably characterized by a three-dimensional shape, in particular by a shell shape.

A device for producing the cover comprises a forming and joining unit. The forming unit is in particular a press such as a forming press, having an upper mold part and a lower mold part. The joining unit is in particular a generator. The joining unit has, for example, a high-frequency generator which generates an electromagnetic field.

For a combined press-forming and press joining method of the covering material blank and of the carrier material blank for the production of the cover, the generator is moreover coupled to the press.

The press can in particular be configured as an electric, hydraulic, or pneumatic press.

The generator generates in particular an electromagnetic field between two electrodes, for example having a high frequency in a range of more than 20 MHZ, in particular of 25 MHZ or 27 MHZ. Herein, heat, also referred to as welding heat, is generated by molecular oscillations (friction heat) directly in the materials to be joined, in particular to be welded, in particular in plastics materials or in the natural material and the plastics material, and in particular in the region of the seam thereof.

The negative mold part and the positive mold part have a negative or positive die shape, respectively, that corresponds to a final shape of the cover.

The method according to the invention for producing the cover comprises the following method steps:
opening a forming and joining unit comprising at least one positive mold part and one negative mold part;
positioning a carrier material blank and a covering material blank having an adhesive non-woven or an adhesive layer disposed therebetween, on one of the mold parts in the opened forming and joining unit;
closing the forming and joining unit by moving the negative mold part in the direction of the positive mold part, or vice versa;
joining the covering material blank to the carrier material blank by means of the adhesive layer or of the adhesive non-woven by welding and molding the cover by pressure forming; and
opening the forming and joining unit and removing the molded cover.

In one refinement, the covering material layer/covering material blank and the carrier material layer/carrier material blank are joined to one another by means of the adhesive layer/adhesive non-woven blank by high-frequency welding. To this end, an in particular electromagnetic field is generated in the region of the joint or the seam of the materials to be joined, for example, wherein these material layers by pressing the negative mold part under pressure onto the positive mold part, or vice versa, are joined to one another by means of the activated adhesive layer or of the adhesive non-woven, and are molded, in particular formed under pressure, to the final shape of the cover.

The present invention will be described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1A is a schematic enlarged vertical sectional view showing a region of a cover molded from a covering material layer and from a carrier material layer, and from an adhesive non-woven or an adhesive layer that is disposed therebetween;

FIG. 1B is a schematic perspective view showing one of various examples of a completed cover;

FIG. 1C is a schematic perspective view showing another of various examples of a completed cover;

FIG. 1D is a schematic perspective view showing another of various examples of a completed cover;

FIG. 2 is a schematic plan view showing an example of a covering material blank;

FIG. 3 is a schematic plan view showing an example of an adhesive non-woven blank;

FIG. 4 is a schematic plan view showing an example of a carrier material blank;

FIG. 5A is a schematic view showing a step in a sequence of a method for producing a cover according to the invention;

FIG. 5B is a schematic view showing another step in the sequence of the method for producing a cover according to the invention;

FIG. 5C is a schematic view showing another step in the sequence of a method for producing a cover according to the invention;

FIG. 5D is a schematic view showing another step in the sequence of the method for producing a cover according to the invention;

FIG. 5E is a schematic view showing another step in the sequence of the method for producing a cover according to the invention;

FIG. 6 is a schematic perspective view showing an example of a forming and joining unit in the opened state;

FIG. 7A is a schematic plan view showing a step in a method sequence for applying an optional pocket to the cover according to the invention;

FIG. 7B is a schematic plan view showing another step in the method sequence for applying an optional pocket to the cover according to the invention;

FIG. 7C is a schematic plan view showing another step in the method sequence for applying an optional pocket to the cover according to the invention;

FIG. 7D is a schematic plan view showing another step in the method sequence for applying an optional pocket to the cover according to the invention;

FIG. 7E is a schematic perspective view showing another step in the method sequence for applying an optional pocket to the cover according to the invention;

FIG. 7F is a schematic plan view showing another step in the method sequence for applying an optional pocket to the cover according to the invention;

FIG. 7G is a schematic plan view showing another step in the method sequence for applying an optional pocket to the cover according to the invention; and

FIG. 7H is a schematic plan view showing another step in the method sequence for applying an optional pocket to the cover according to the invention.

### DESCRIPTION OF THE PREFERRED EMBODIMENTS

Referring to the drawings, equivalent parts are provided with the same reference signs in all figures.

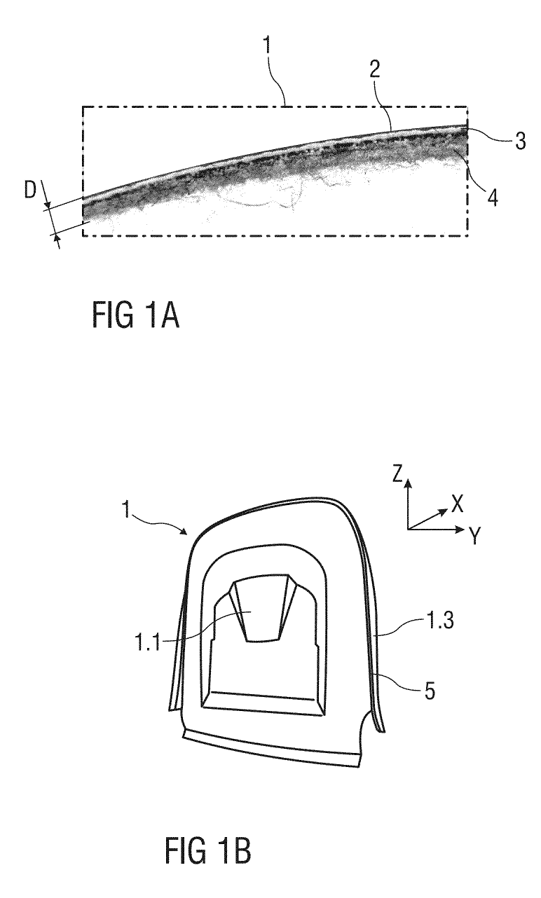

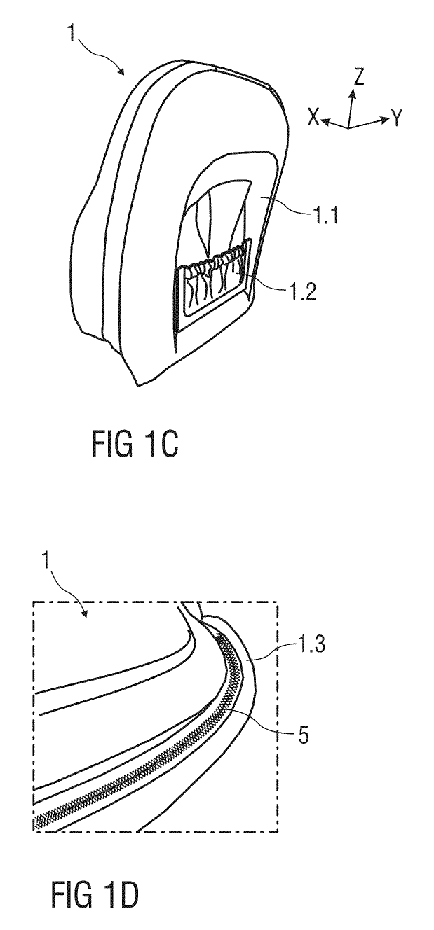

FIG. 1A schematically shows in an enlarged vertical section a region of a cover 1. The cover 1 is, for example, a backrest cover, a lateral cover, a backrest shell, or a seat shell for a vehicle seat.

The cover 1 is shaped from a covering material layer 2, from an adhesive non-woven 3 or an adhesive layer, and from a carrier material layer 4.

The adhesive non-woven 3 can be configured as a separate tier. Alternatively, an adhesive material or substance can be applied as an adhesive layer to the carrier material layer 4, or be prefabricated on the latter. The invention will be described hereunder by means of a separate adhesive non-woven 3. The invention is applicable in an analogous manner to a carrier material layer 4 prefabricated with an adhesive layer.

The adhesive non-woven 3 is disposed between the covering material layer 2 and the carrier material layer 4. The covering material layer 2 and the carrier material layer 4 are joined to one another, in particular in a materially integral manner, by means of the adhesive non-woven 3. The trim 1 according to the invention is thus made as a composite component.

The covering material layer 2 herein can be configured so as to be thin, whereas the carrier material layer 4 can be configured to be thick in comparison to the covering material layer 2. In other words, the covering material layer 2 has a smaller thickness than the carrier material layer 4.

The cover 1 surprisingly has a thickness D in a range from 3 mm to 5 mm, in particular from 4.0 mm to 4.5 mm, and is thus configured so as to be significantly thinner in relation to conventional covers having thicknesses of more than 5 mm or 8 mm.

Moreover, the cover 1 can have a hardness of more than 60 Shore-A, in particular of 65 Shore-A in the case of a 1000 g carrier material blank 4.1 (in particular a 1000 g carrier non-woven), or of 62 Shore-A in the case of an 800 g carrier material blank 4.1 (in particular an 800 g carrier non-woven).

FIGS. 1B to 1D schematically show various embodiments of a completed cover 1 in perspective illustrations.

FIG. 1B shows a rear side of a cover 1 which is shaped as a shell-shaped backrest cover or a backrest upholstery element. The rear side of the cover 1 has a depression 1.1. The depression 1.1 is molded in the cover 1 during the production of the latter. The depression 1.1 serves as legroom, for example.

The cover 1 along an encircling edge 1.3 can have a fastening means 5, in particular a zip fastener for a covering to be applied.

FIG. 1C shows a further exemplary embodiment of a rear side of the cover 1 which is formed as a backrest cover or as a shell-shaped backrest upholstery element. The rear side of the cover 1 additionally has a pocket 1.2 in the depression 1.1. The pocket 1.2 can be fixed in the depression 1.1 so as to be releasable in a simple manner. The pocket 1.2 is optional.

FIG. 1D shows the encircling edge 1.3 of the cover 1 in an enlarged illustration.

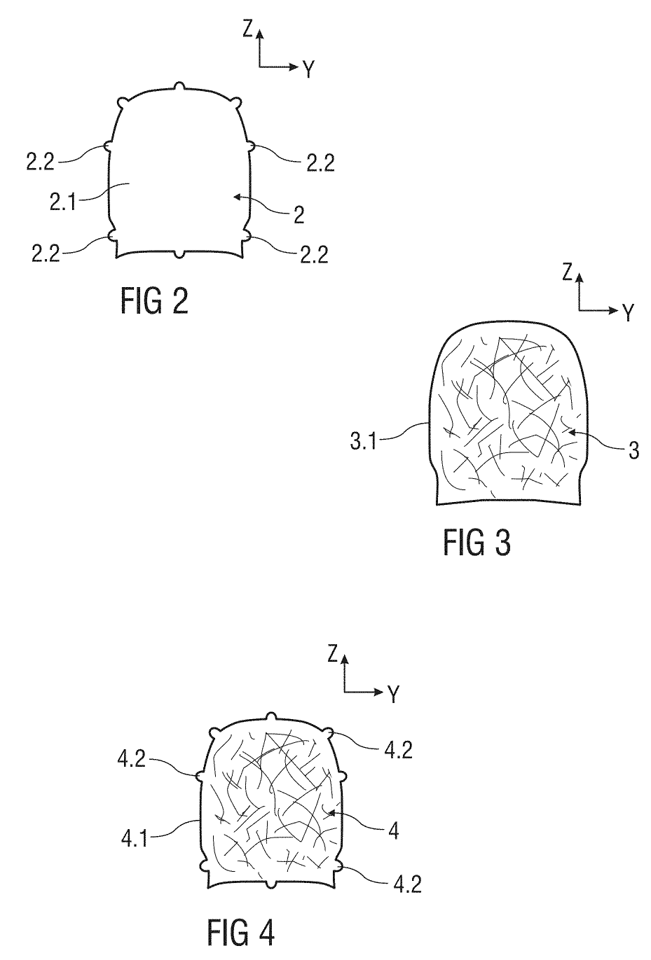

FIG. 2 schematically shows an example of a covering material blank 2.1 of the covering material layer 2 for the cover 1 in the plan view.

The covering material of the covering material layer 2 is, for example, a vinyl material, in particular a non-laminated vinyl material. The covering material can be a polyvinylchloride, for example. Alternatively, the covering material can be a textile material, in particular a woven fabric, or a natural material, in particular leather. The covering material is optionally pre-treated. The covering material is available in particular as an endless material. In order for the cover 1 to be produced, the covering material is cut to size as the covering material blank 2.1 so as to correspond to the final shape of the cover 1. The covering material can be reinforced and/or coated. The covering material can also be configured so as to be smooth or porous.

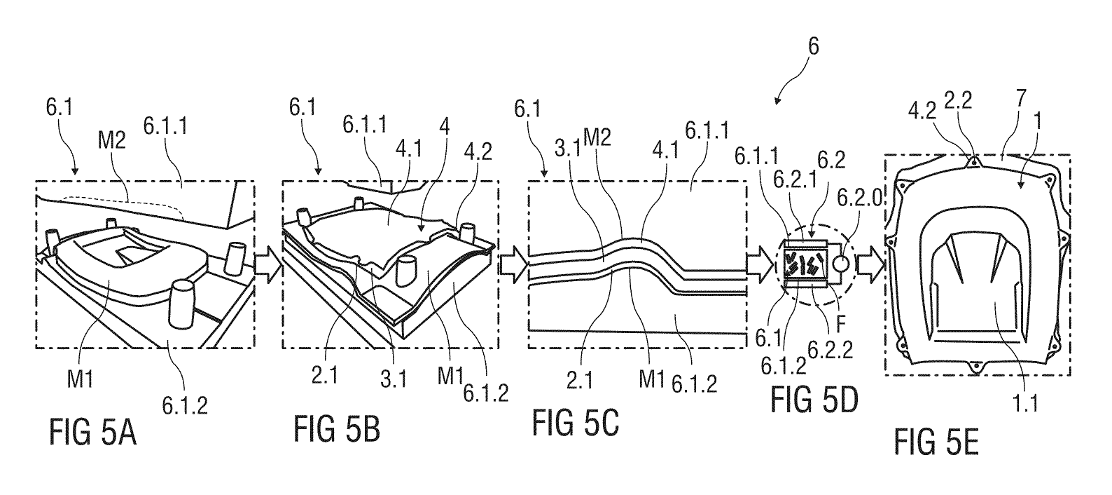

The covering material blank 2.1, along the external contour thereof, herein can have protruding tabs 2.2 or other suitable fastening lugs. Upon completion of the cover 1 for a seat such as a vehicle seat, these tabs 2.2 serve, for example, for fastening a seat covering 7 (trim cover) illustrated in FIG. 5E.

FIG. 3 schematically shows an example of an adhesive non-woven 3 in the plan view. The adhesive non-woven 3 is available in particular as an endless material. In order for the cover 1 to be produced, the adhesive non-woven 3 as an adhesive non-woven blank 3.1 is cut to size so as to correspond to the final shape of the cover 1.

The adhesive non-woven blank 3.1 herein has a shape that corresponds in particular to that of the covering material blank 2.1 and to that of the carrier material blank 4.1. In particular, the dimensions and/or the size of the adhesive non-woven blank 3.1 are largely identical to the dimensions and/or the size of the covering material blank 2.1 and/or of the carrier material blank 4.1. The adhesive non-woven blank 3.1 has a smooth contour without tabs or lugs. In the case of either of the covering material blank 2.1 or the carrier material blank 4.1 being configured so as to be smaller, the shape of the adhesive non-woven blank 3.1 herein corresponds substantially to the smaller shape of the covering material blank 2.1 or of the carrier material blank 4.1.

The adhesive non-woven 3 is in particular a water-free and/or solvent-free adhesive non-woven, for example a co-polyester non-woven or a thermoplastic non-woven. The adhesive non-woven 3 has in particular an open structure. The adhesive non-woven 3 is characterized by cavities. Upon activation, in particular by heat and pressure over a specific time, an open adhesive connection is thus configured between the covering material layer 2 and the carrier material layer 4 to be joined. On account thereof, the finished cover 1 can be configured as a composite component so as to be breathable.

FIG. 4 schematically shows an example of a carrier material blank 4.1 of the carrier material layer 4 in the plan view.

The carrier material is available in particular as an endless material. In order for the cover 1 to be produced, the carrier material of the carrier material layer 4 as the carrier material blank 4.1 is cut to size so as to correspond to the final shape of the cover 1.

The carrier material blank 4.1 along the external contour thereof herein can have protruding tabs 4.2 or other suitable fastening lugs. Upon completion of the cover 1, these tabs 4.2 serve for fastening the seat covering 7 (trim cover), for example.

The carrier material is in particular configured as a carrier non-woven, for example as a press felt or a carpet or a warp or weft knitted fabric. The carrier non-woven is formed, for example, from plastics fibers and/or natural fibers and/or reinforcement fibers. The fibrous material can be pre-shaped and optionally be pre-treated. The fibrous material can be formed from one or more different materials, for example from polyester, polyethylene, polypropylene and/or polyurethane. Said fibrous material can be formed from randomly oriented fibers, in particular from recycled or virgin natural and/or plastics fibers. The carrier non-woven can be formed from a three-dimensional stochastically oriented fibrous material. Alternatively, said fibrous material can be a woven or a non-woven carrier fabric. Said fibrous material can optionally be thermally pre-treated. Said fibrous material herein is advantageously a three-dimensional stochastically oriented fibrous material. Plastics fibers are formed from a thermoplastic material, for example, in particular from a modified and weldable thermoplastic material. For example, the plastics fibers are formed from polyethylene terephthalate (PET), from polyester, or from a synthetic polymer, in particular from polylactic acid (PLA). A mixture of fibers from various plastics is also possible.

FIGS. 5A to 5E schematically show a sequence of a method for producing a cover 1 according to the invention.

A forming and joining unit 6 which is partially illustrated in FIGS. 5A to 5D is provided for producing the cover 1.

FIG. 5A shows in part a forming unit 6.1 of the forming and joining unit 6. The forming unit 6.1 is configured, for example, as a press, in particular a forming press. The press can be configured in particular as an electric, hydraulic, or pneumatic press.

The forming unit 6.1 comprises at least one negative mold part 6.1.1 and one positive mold part 6.1.2. The negative mold part 6.1.1 in the exemplary embodiment is an upper mold part, in particular a negative press mold part. The positive mold part 6.1.2 is, for example, a lower mold part, for example a positive press mold part.

The positive mold part 6.1.2 has a die M1 which corresponds to the final shape of the cover 1 to be formed. The negative mold part 6.1.1 has a negative die M2 which corresponds to the die M1. In other words, the negative mold part 6.1.1 and the positive mold part 6.1.2 have a negative or positive die shape M2 and M1, respectively, which corresponds to a final shape, in particular a 3D shape, for example a shell shape, of the cover 1.

The forming unit 6.1 is shown in the opened state. This means that the mold parts 6.1.1 and 6.1.2 are disposed so as to be mutually spaced apart. On account thereof, the loading or the introduction of the blanks, that is to say the covering material blank 2.1, the adhesive non-woven blank 3.1, and the carrier material blank 4.1, into the forming unit 6.1 is enabled.

In an alternative exemplary embodiment (not illustrated in more detail), of an adhesive layer prefabricated on the carrier material blank 4.1, the carrier material blank 4.1 conjointly with the prefabricated adhesive layer is incorporated into the forming unit 6.1 in such a manner that the adhesive layer points in the direction of the cover material blank 2.1 and in the positioned state is disposed between the cover material blank 2.1 and the carrier material blank 4.1.

The mold parts 6.1.1 and 6.1.2 are formed in particular from aluminum. On account thereof, covers 1 from various materials can be molded and produced in one and the same forming unit 6.1 in a manner independent of the material used (woven fabrics, vinyl, or leather).

FIG. 5B shows the opened forming unit 6.1 having blanks, i.e. the covering material blank 2.1, the adhesive non-woven blank 3.1, and the carrier material blank 4.1, disposed on top of one another on the positive mold part 6.1.2. In particular, the blanks are disposed and mutually aligned on top of one another in tiers, for example in the manner of a sandwich.

FIG. 5C shows the forming unit 6.1 in the closed state and having blanks, i.e. the covering material blank 2.1, the adhesive non-woven blank 3.1, and the carrier material blank 4.1, disposed between the mold parts 6.1.1 and 6.1.2.

FIG. 5D shows a joining unit 6.2 of the forming and joining unit 6.

The joining unit 6.2 is in particular a generator 6.2.0. The generator 6.2.0 is in particular a high-frequency generator which in the region of the blanks to be joined, such as the covering material blank 2.1, the adhesive non-woven blank 3.1, and the carrier material blank 4.1, generates an electromagnetic field F so as to join said blanks to be joined by means of friction heat from excited molecules.

To this end, the generator 6.2.0 for producing the cover 1 is coupled to the forming unit 6.1 for the pressure-forming and pressure-joining method of the covering material blank 2.1 and of the carrier material blank 4.1 by means of the adhesive non-woven blank 3.1.

The generator 6.2.0 comprises, for example, two electrodes 6.2.1 and 6.2.2 which are each coupled to one of the mold parts 6.1.1 and 6.1.2, respectively, of the forming unit 6.1. The mold parts 6.1.1 and 6.1.2 per se herein can form the electrodes 6.2.1 and 6.2.2, respectively. Alternatively, the electrodes 6.2.1 and 6.2.2 can be configured separately and integrated in the mold parts 6.1.1 and 6.1.2, respectively.

The generator 6.2.0, in particular a high-frequency generator, generates the electromagnetic field F between the two electrodes 6.2.1 and 6.2.2, for example with a high frequency in a range of more than 20 MHZ, in particular of 25 MHZ or 27 MHZ. Herein, heat, also referred to as welding heat, is generated by molecular oscillations (friction heat) directly in the materials to be joined, in particular to be welded, in particular in the blanks such as the covering material blank 2.1, the adhesive non-woven blank 3.1, and the carrier material blank 4.1. An activation of the adhesive or of the adhesive material of the adhesive non-woven blank 3.1 or of the adhesive layer, and melting and fusing of said adhesive non-woven blank 3.1 or of said adhesive layer to the covering material of the covering material layer 2 and the carrier material of the carrier material layer 4 take place herein, said materials/layers being joined to one another on account thereof.

Heating of the forming unit 6.1, in particular of the mold parts 6.1.1, 6.1.2 thereof, and/or of the covering material, the carrier material, and/or of the adhesive prior to and/or during the joining of the layers is not required. On account thereof the cover 1 can be produced in a simple and cost-effective manner in different material variations, using one and the same forming and joining unit 6.

FIG. 5E shows the molded cover 1 with the tabs 2.2 and 4.2 for fastening the cover 1 to the seat covering 7 upon removal of the cover 1 from the forming and joining unit 6.

The method according to the invention for producing the cover 1 in summary comprises at least the following method steps:
opening the forming and joining unit 6 (FIG. 5A);
positioning the covering material blank 2.1, the adhesive non-woven blank 3.1, and the carrier material blank 4.1 in the opened forming and joining unit 6, for example on the positive mold part 6.1.2 (FIG. 5B);
closing the forming and joining unit 6.1, for example by moving the negative mold part 6.1.1 in the direction of the positive mold part 6.1.2 (FIG. 5C);
joining the covering material blank 2.1 to the carrier material blank 4.1 by means of the adhesive non-woven 3 or of the adhesive layer, by welding and molding the cover 1 by pressure forming (FIG. 5D); and
opening the forming and joining unit 6 and removing the molded cover 1 (FIG. 5E).

Herein, the covering material layer/blank 2.1 and the carrier material layer/blank 4.1 can be joined to one another by means of the adhesive layer/non-woven blank 3.1 by high-frequency welding, for example. To this end, an in particular electromagnetic field F is generated in the region of the joint or seam of the materials to be joined, for example, wherein these material layers by means of the activated adhesive layer or of the adhesive non-woven blank 3.1 are joined to one another into the final shape of the cover 1 and molded, in particular pressure-molded by pressing the negative mold part 6.1.1 under pressure onto the positive mold part 6.1.2, or vice versa.

The completed cover 1 molded to the final shape can then be sewn to the seat covering 7, for example, or be connected to the latter by means of a zip fastener. The cover 1 can be attached and fastened to the seat, in particular an upholstery element or a seat support, separately or conjointly with the seat covering 7.

The cover 1 can be part of a seat component and, for example, clad/cover a lateral face or a backrest face.

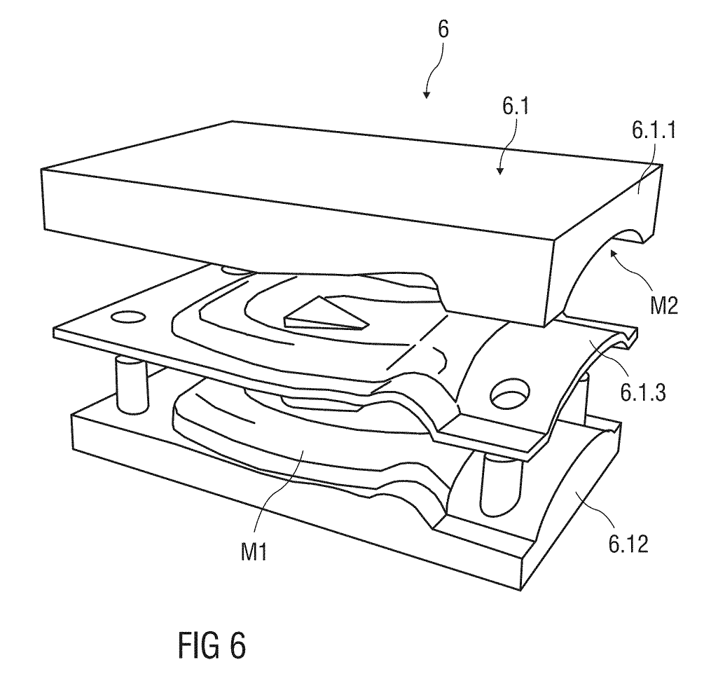

FIG. 6 schematically shows an exemplary embodiment of the forming and joining unit 6 in the opened state in a perspective illustration. The forming and joining unit 6 can additionally have a fixing frame 6.1.3 in order for the blanks such as the covering material blank 2.1, the adhesive non-woven blank 3.1, and the carrier material blank 4.1 to be positioned, mutually aligned and fixed in the forming and joining unit 6.

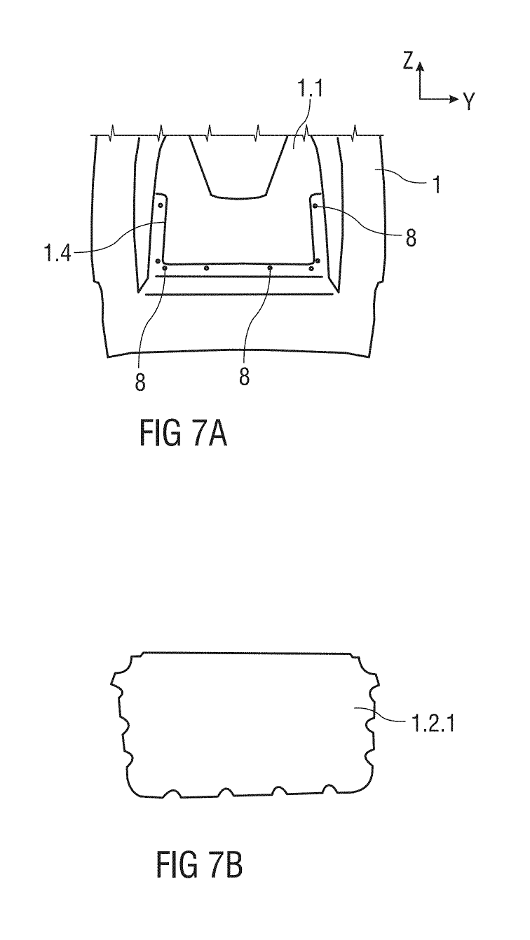

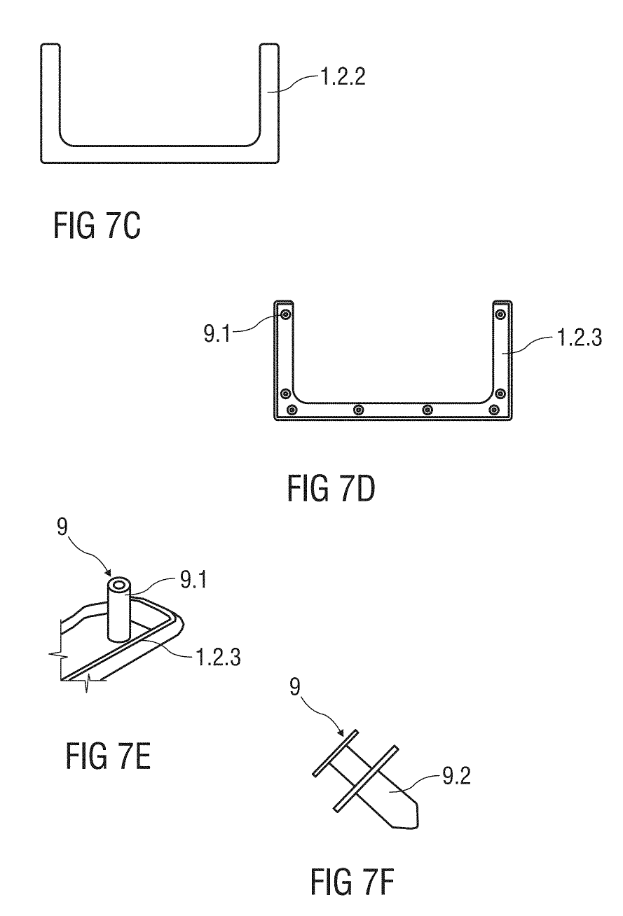

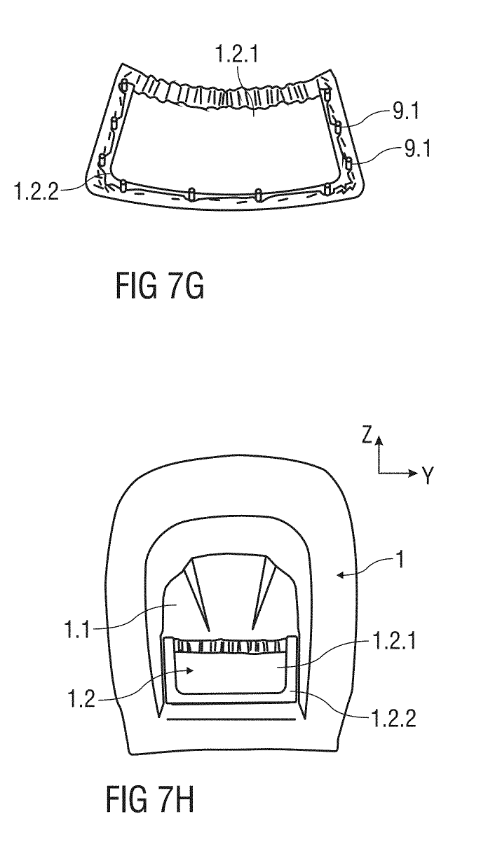

FIGS. 7A to 7H schematically show a method sequence for attaching an optional pocket 1.2 to the cover 1 according to the invention.

When the exemplary cover 1 is being molded and joined as per FIGS. 7A to 7H in the forming and joining unit 6, fastening openings 8 are inserted or molded into said cover 1. A shoulder 1.4 can optionally be molded into the molded depression 1.1. Alternatively, the fastening openings 8 and/or the shoulder 1.4 can be subsequently incorporated into the already molded and joined cover 1 (as has been described above by means of FIGS. 5A to 5E).

FIG. 7A in an exemplary manner shows the cover 1 having fastening openings 8 and the shoulder 1.4 in the region of the depression 1.1.

FIG. 7B in an exemplary manner shows a pocket material blank 1.2.1.

FIG. 7C shows an example of a fastening frame 1.2.2 (also referred to as a bezel frame) from the outside thereof for the pocket 1.2.

FIG. 7D shows an example of an internal side 1.2.3 (also referred to as a fastening side) of the fastening frame 1.2.2 for the pocket 1.2.

FIGS. 7E and 7F show examples of fastening means 9, in particular a fastening pin 9.1, or a fastening rivet 9.2, respectively, or fastening screws.

FIG. 7G shows an example of the pocket 1.2, the pocket material blank 1.2.1 thereof being fastened to the cover 1 by means of the fastening frame 1.2.2. The fastening frame 1.2.2 herein can be obscured by the carrier material so as not to be visible from the outside, as is shown in FIG. 7G.

FIG. 7H shows an alternative example, having a fastening frame 1.2.2 that is visible from the outside, in a state in which said fastening frame 1.2.2 is fastened, in particular plug-fitted or riveted, to the cover 1.

While specific embodiments of the invention have been shown and described in detail to illustrate the application of the principles of the invention, it will be understood that the invention may be embodied otherwise without departing from such principles.

### APPENDIX

List of reference designations

| | |
|---|---|
| 1 | Cover |
| 1.1 | Depression |
| 1.2 | Pocket |
| 1.2.1 | Pocket material blank |
| 1.2.2 | Fastening frame |
| 1.2.3 | Internal side |
| 1.3 | Edge |
| 1.4 | Shoulder |
| 2 | Covering material layer |
| 2.1 | Covering material blank |
| 2.2 | Tab |
| 3 | Adhesive non-woven |
| 3.1 | Adhesive non-woven blank |
| 4 | Carrier material layer |
| 4.1 | Carrier material blank |
| 4.2 | Tab |
| 5 | Fastening means |
| 6 | Forming and joining unit |
| 6.1 | Forming unit |
| 6.1.1 | Negative mold part |
| 6.1.2 | Positive mold part |
| 6.1.3 | Fixing frame |
| 6.2 | Joining unit |
| 6.2.0 | Generator |
| 6.2.1 | Electrode |
| 6.2.2 | Electrode |
| 7 | Seat covering |
| 8 | Fastening opening |
| 9 | Fastening means |
| 9.1 | Fastening pin |
| 9.2 | Fastening rivet |
| D | Thickness |
| F | Electromagnetic field |
| M1, M2 | Dies |

What is claimed is:

1. A vehicle seat backrest cover or vehicle seat lateral cover, comprising:
a covering material layer provided from a covering material blank;
a carrier material layer provided from a carrier material blank; and
an adhesive layer comprising an adhesive non-woven disposed between the covering material layer and the carrier material layer, wherein the covering material blank and the carrier material blank are molded together with the adhesive non-woven disposed therebetween.

2. A vehicle seat backrest cover or vehicle seat lateral cover according to claim 1, wherein a covering material of the covering material layer, and a carrier material of the carrier material layer are joined to one another by the adhesive layer by a pressure-forming and pressure joining method.

3. A vehicle seat backrest cover or vehicle seat lateral cover according to claim 1, wherein the covering material and the carrier material are joined to one another by the adhesive layer by a pressure-forming and pressure-joining method by applied high frequency energy.

4. A vehicle seat backrest cover or vehicle seat lateral cover according to claim 1, wherein the covering material is a vinyl material, a textile material, or a natural material.

5. A vehicle seat backrest cover or vehicle seat lateral cover according to claim 1, wherein the carrier material is a carrier non-woven comprising a press felt or press non-woven.

6. A vehicle seat backrest cover or vehicle seat lateral cover according to claim 1, wherein the adhesive non-woven is a co-polyester non-woven or a thermoplastic non-woven.

7. A vehicle seat backrest cover or vehicle seat lateral cover according to claim 1, wherein the cover has a thickness in a range from 3 mm to 5 mm.

8. A vehicle seat backrest cover or vehicle seat lateral cover according to claim 1, wherein the cover has a thickness in a range from 4.0 mm to 4.5 mm.

9. A vehicle seat backrest cover or vehicle seat lateral cover according to claim 1, wherein the cover has a hardness of more than 60 Shore-A in with the carrier material layer comprising a 1000 g carrier non-woven.

10. A vehicle seat backrest cover or vehicle seat lateral cover according to claim 1, wherein the cover has a three-dimensional shape comprising a shell shape.

11. A method for producing a vehicle seat backrest cover or vehicle seat lateral cover comprising a covering material layer provided from a covering material blank, a carrier material layer provided from a carrier material blank and an adhesive layer comprising an adhesive non-woven disposed between the covering material layer and the carrier material layer, the method comprising the steps of:
opening a forming and joining unit comprising at least one positive mold part and one negative mold part;
positioning the carrier material blank and the covering material blank, with an adhesive non-woven or an adhesive layer disposed therebetween, on one of the mold parts in the opened forming and joining unit;
closing the forming and joining unit by moving the negative mold part in the direction of the positive mold part, or vice versa;
joining the covering material blank to the carrier material blank by means of the adhesive non-woven by welding and molding the cover by pressure forming; and
opening the forming and joining unit and removing the molded cover.

12. A method according to claim 11, wherein the covering material and the carrier material are joined to one another by the adhesive layer by the pressure-forming and pressure joining method by applied high frequency energy.

13. A method according to claim 11, wherein the covering material is a vinyl material, a textile material, or a natural material.

14. A method according to claim 11, wherein the carrier material is a carrier non-woven comprising a press felt or press non-woven.

15. A method according to claim 11, wherein the adhesive non-woven is a co-polyester non-woven or a thermoplastic non-woven.

16. A method according to claim 11, wherein the cover has a thickness in a range from 3 mm to 5 mm.

17. A method according to claim 11, wherein the cover has a thickness in a range from 4.0 mm to 4.5 mm

18. A method according to claim 11, wherein the cover has a hardness of more than 60 Shore-A in with the carrier material layer comprising a 1000 g carrier non-woven.

19. A method according to claim 11, wherein the cover has a three-dimensional shape comprising a shell shape.
